(19) United States
(12) Patent Application Publication
(10) Pub. No.: US 2023/0398571 A1
(43) Pub. Date: Dec. 14, 2023

(54) CORROSION-RESISTANT MAGNESIUM ALLOY WITH A MULTI-LEVEL PROTECTIVE COATING AND PREPARATION PROCESS THEREOF

(71) Applicant: The Boeing Company, Arlington, VA (US)

(72) Inventors: Dingfei Zhang, Chongqing (CN); Yuping Liu, Chongqing (CN); Chao Miao, Chongqing (CN); Hanxi Zhao, Chongqing (CN); Libin Zhao, Chongqing (CN)

(73) Assignee: The Boeing Company, Arlington, VA (US)

(21) Appl. No.: 18/250,597

(22) PCT Filed: Jan. 3, 2022
(86) PCT No.: PCT/US2022/011020

§ 371 Date: Apr. 26, 2023

(30) Foreign Application Priority Data
Jan. 4, 2021 (CN) 202110002962.0

(51) Int. Cl. B05D 7/00; B05D 7/14

(52) U.S. Cl. CPC B05D 7/5483; B05D 7/51; B05D 7/14; B05D 2202/20; B05D 2504/00; B05D 2503/00

(57) ABSTRACT

A corrosion-resistant magnesium alloy with a multi-level protective coating, and to a preparation process thereof. The magnesium alloy with a multi-level protective coating comprises a magnesium alloy substrate and a multi-level protective coating. The multi-level protective coating comprises a micro-arc oxidation layer of magnesium alloy provided on the surface of the magnesium alloy substrate, an epoxy primer layer provided on the surface of the micro-arc oxidation layer of magnesium alloy, and a polyurethane topcoat layer provided on the surface of the epoxy primer layer. The magnesium alloy with a multi-level protective coating effectively integrates the excellent adhesion of the micro-arc oxidation layer and the excellent anti-corrosion effect of the organic coating. The process for the preparation of the magnesium alloy with a multi-level protective coating is cost-effective, simple, suitable for large-area and large-scale magnesium alloy treatment, and suitable for the development for large-area scale industrialization. The magnesium alloy with a multi-level protective coating is characterized by a good adhesion and an excellent salt spray resistance, exhibits a period of neutral salt spray resistance test of greater than 1,000 hours, and can be applied in the automotive industry and the aviation industry.

### PRIORITY

This application claims priority from Chinese Pat. App. No. 202110002962.0 filed on Jan. 4, 2021.

### FIELD

The disclosure relates to a technical field of magnesium alloy surface treatment, and in particular, to a highly corrosion-resistant magnesium alloy with a multi-level protective coating and preparation process thereof.

### BACKGROUND

Magnesium is an important green light metal material (which has a density of about 1.74 g/cm³). Magnesium alloy is an alloy based on magnesium added with other elements. With the demand for energy saving, emission reduction and environmental protection, magnesium alloy materials have the advantages of high specific strength, good shock absorption, abundant magnesium mineral resources and recyclability and the like.

These advantages make magnesium alloys have broad application prospects in the automotive industry, aviation industry and other fields. While high-strength and high-plasticity magnesium alloy materials have been developed, improvement of corrosion resistance is an important strategy for expanding the practical application of magnesium alloy materials.

The standard electrode potential of magnesium is relatively negative, and its value is about −2.37 V (compared to the standard hydrogen electrode (NHE)), which is about 2 V lower than that of iron and about 0.7 V lower than that of aluminum. Magnesium has high chemical activity and is very easy to be corroded. At present, there are two main ways to improve the corrosion resistance of magnesium alloy materials: one is to add to the magnesium alloy material with alloy elements to improve the corrosion resistance of the magnesium alloy from the material itself; the second is to use surface protection technology, the common technologies includes Chemical conversion, Anodizing, Micro-arc oxidation, Electroplating, Electroless plating, and Organic coating, etc., which can mainly generate a protective layer on the surface of the magnesium alloy so as to isolate the magnesium alloy material from the corrosion medium, thereby effectively improving corrosion resistance of the magnesium alloy material. According to the current research and the existing situation, a single treatment coating of the magnesium alloy surface is difficult to make the period of neutral salt spray resistance test of the deformed magnesium alloy (such as AZ31, etc.) of more than 1000 hours. In other words, the micro-arc oxide film or organic coating is not suitable to be used as an anticorrosive film alone.

### SUMMARY

The present disclosure provide a highly corrosion-resistant magnesium alloy with a multi-level protective coating and the preparation process thereof.

In one example, the disclosed magnesium alloy with a multi-level protective coating includes a magnesium alloy substrate and a multi-level protective coating, wherein the multi-level protective coating comprises:
a micro-arc oxidation layer of magnesium alloy provided on the surface of the magnesium alloy substrate,
an epoxy primer layer provided on the surface of the micro-arc oxidation layer of magnesium alloy, and
a polyurethane topcoat layer provided on the surface of the epoxy primer layer.

Further, in the above-mentioned magnesium alloy with a multi-level protective coating, the micro-arc oxidation layer of magnesium alloy has a thickness of about 5 μm to about 20 μm, the epoxy primer layer has a thickness of about 10 μm to about 30 μm, and the polyurethane topcoat layer has a thickness of about 10 μm to about 50 μm.

Furthermore, in the above-mentioned magnesium alloy with multi-level protective coating, the magnesium alloy substrate is selected from a group consisting of AZ21 series magnesium alloy, AZ31 series magnesium alloy, AZ91 series magnesium alloy and ZE41 series magnesium alloy, and other magnesium alloys.

Further still, among the above-mentioned magnesium alloy with multi-level protective coating, the magnesium alloy with multi-level protective coatings has a period of neutral salt spray test of more than about 1,000 hours, preferably more than about 1,100 hours, and most preferably, more than about 1,200 hours, in accordance with ASTM B117-16.

Further, among the above-mentioned magnesium alloy with multi-level protective coating, the magnesium alloy with multi-level protective coating has a degree of blistering according to ASTM D1654-08(2016) of up to 10, a degree of rusting according to ASTM D1654-08(2016) of up to 10, a degree of cracking according to ISO 4628-4 (2016) of up to 0, and a degree of flaking according to ISO 4628-5 (2016) of up to 0.

According to another aspect of the disclosure, there is provided a process for preparing a magnesium alloy with a multi-level protective coating, comprising:
pretreatment of a magnesium alloy substrate, comprising polishing the magnesium alloy substrate, followed by acid pickling and water washing of the polished magnesium alloy substrate sequentially, to obtain a pretreated magnesium alloy substrate;
micro-arc oxidation of the pretreated magnesium alloy substrate to obtain a micro-arc oxidation layer of magnesium alloy;
formation of an epoxy primer layer on the surface of the micro-arc oxidation layer of magnesium alloy; and
formation of a polyurethane topcoat layer on the surface of the epoxy primer layer.

Furthermore, in the above-mentioned process for preparing a magnesium alloy with a multi-level protective coating, the pretreatment of the magnesium alloy substrate comprises:
polishing the magnesium alloy substrate with water sandpaper from coarse to fine of 200 #, 400 #, 600 #, 800 #, 1000 #, 1200 # to remove the burrs at the margins and corners to obtain a preliminary-polished magnesium alloy substrate;
polishing the preliminary-polished magnesium alloy substrate with sandpaper or abrasive wheel from coarse to fine until the surface of the preliminary-polished magnesium alloy substrate became smooth, to obtain the polished magnesium alloy substrate; and
pickling the polished magnesium alloy substrate with an acid of pH=about 0.5 to about 2 and washing with pure water to obtain the pretreated magnesium alloy substrate.

Further still, in the above-mentioned process for preparing a magnesium alloy with a multi-level protective coating, the process further comprises coarsen treatment of the epoxy primer layer before formation of a polyurethane topcoat layer on the surface of the epoxy primer layer.

According to yet another aspect of the disclosure, there is provided a magnesium alloy with a multi-level protective coating produced by above process for preparing a magnesium alloy with a multi-level protective coating.

By applying the technical solutions of the present disclosure, the magnesium alloy has been successfully improved to achieve a period of neutral salt spray test according to ASTM B117-16 of more than about 1,000 h, a degree of blistering according to ASTM D1654-08(2016) of up to 10, a degree of rusting according to ASTM D1654-08(2016) of up to 10, a degree of cracking according to ISO 4628-4 (2016) of up to 0, and a degree of flaking according to ISO 4628-5 (2016) of up to 0.

### BRIEF DESCRIPTION OF THE DRAWINGS

The accompanying drawings forming part of this application are used to provide a further understanding of the disclosure. The exemplary embodiments of the disclosure and their description are used to explain the disclosure and do not constitute an undue limitation of the disclosure. In the drawings:

FIG. 1 shows the surface morphology of three samples made according to Example 1 of the disclosure before the neutral salt spray experiment, wherein each sample comprises polyurethane topcoat/epoxy primer/micro-arc oxidation layer/AZ21.

FIG. 2 shows the surface morphology of three samples made according to Example 1 of the disclosure after 1,000 hours of the un-scribed neutral salt spray test, wherein each sample comprises polyurethane topcoat/epoxy primer/micro-arc oxidation layer/AZ21.

FIG. 3 shows the surface morphology of three samples made according to Example 1 of the disclosure after 1,000 hours of the scribed neutral salt spray test, wherein each sample comprises polyurethane topcoat/epoxy primer/micro-arc oxidation layer/AZ21.

FIG. 4 shows the surface morphology of three samples made according to Example 2 of the disclosure before the neutral salt spray experiment, wherein each sample comprises polyurethane topcoat/epoxy primer/micro-arc oxidation layer/AZ21.

FIG. 5 shows the surface morphology of three samples made according to Example 2 of the disclosure after 1,200 hours of the un-scribed neutral salt spray test, wherein each sample comprises polyurethane topcoat/epoxy primer/micro-arc oxidation layer/AZ21.

FIG. 6 shows the surface morphology of three samples made according to Example 2 of the disclosure after 1,200 hours of the scribed neutral salt spray test, wherein each sample comprises polyurethane topcoat/epoxy primer/micro-arc oxidation layer/AZ21.

FIG. 7 shows the surface morphology of three samples made according to Comparative Preparation Example 1 before the neutral salt spray experiment, wherein each sample comprises epoxy primer/micro-arc oxidation layer/AZ21.

FIG. 8 shows the surface morphology of three samples made according to Comparative Preparation Example 1 after 192 hours of the un-scribed neutral salt spray test, wherein each sample comprises epoxy primer/micro-arc oxidation layer/AZ21 and corrosion portion is indicated with oval.

FIG. 9 shows the surface morphology of three samples made according to Comparative Preparation Example 1 after 192 hours of the scribed neutral salt spray test, wherein each sample comprises epoxy primer/micro-arc oxidation layer/AZ21 and corrosion portion is indicated with oval.

FIG. 10 shows the surface morphology of three samples made according to Comparative Preparation Example 2 before the neutral salt spray experiment, wherein each sample comprises micro-arc oxidation layer/AZ21.

FIG. 11 shows the surface morphology of three samples made according to Comparative Preparation Example 2 after 96 hours of the un-scribed neutral salt spray test, wherein each sample comprises micro-arc oxidation layer/AZ21 and corrosion portion is indicated with oval.

FIG. 12 shows the surface morphology of three samples made according to Comparative Preparation Example 2 after 96 hours of the scribed neutral salt spray test, wherein each sample comprises micro-arc oxidation layer/AZ21 and corrosion portion is indicated with oval.

### DETAILED DESCRIPTION

It should be noted that the embodiments in the disclosure and the features in the embodiments can be combined with each other, unless a conflict prevents such combination. The disclosure will be described in detail below in conjunction with the embodiments. The following detailed description of the disclosure does not constitute a limitation on the protection scope of the claims of the present disclosure.

The present disclosure combines the micro-arc oxidation layer and the epoxy primer layer with the polyurethane topcoat layer to treat the magnesium alloy surface so as to form a multi-level protective coating, thereby providing a magnesium alloy with the multi-level protective coating suitable for large-scale, large-area industrial production.

A magnesium alloy with a multi-level protective coating according to the disclosure, wherein the multi-level protective coating comprises a micro-arc oxidation layer of magnesium alloy provided on the surface of the magnesium alloy substrate, an epoxy primer layer provided on the surface of the micro-arc oxidation layer of magnesium alloy, and a polyurethane topcoat layer provided on the surface of the epoxy primer layer.

The inventors of the disclosure innovatively propose a magnesium alloy with a multi-level protective coating, wherein the multi-level protective coating comprises a micro-arc oxidation layer, an epoxy primer layer and a polyurethane topcoat layer. The good compactness of the epoxy primer layer and the polyurethane topcoat layer compensates for the porosity of the micro-arc oxidation layer, and the good adhesion of the micro-arc oxidation layer solves the problem of the poor adhesion of the organic coating primer.

In addition, the use of epoxy resin as the primer layer on the micro-arc oxidation layer and polyurethane as the topcoat layer was innovatively proposed according to the disclosure, which successfully improves the exposure period of neutral salt spray test according to ASTM B117-16 of the magnesium alloy to be more than 1,000 h such that the corrosion resistance of magnesium alloy in this system environment is comparable to or even better than that of aluminum alloy.

In a typical embodiment of the disclosure, there is provided a magnesium alloy with a multi-level protective coating, comprising: a magnesium alloy substrate; and a multi-level protective coating, wherein the multi-level protective coating comprising:
a micro-arc oxidation layer of magnesium alloy provided on the surface of the magnesium alloy substrate,
an epoxy primer layer provided on the surface of the micro-arc oxidation layer of magnesium alloy, and
a polyurethane topcoat layer provided on the surface of the epoxy primer layer.

In the magnesium alloy with a multi-level protective coating according to the disclosure, the good compactness of the epoxy primer layer and the polyurethane topcoat layer compensates for the porosity of the micro-arc oxidation layer, while the good adhesion of the micro-arc oxidation layer makes up for the poor adhesion of the organic coating primer, such that, since a multi-level protective coating including a micro-arc oxidation layer of magnesium alloy, an epoxy primer layer and a polyurethane topcoat layer is incorporated on the magnesium alloy substrate, the magnesium alloy is improved to have a period of neutral salt spray test according to ASTM B117-16 of more than about 1,000 h, a degree of blistering according to ASTM D1654-08(2016) of up to 10, a degree of rusting according to ASTM D1654-08(2016) of up to 10, a degree of cracking according to ISO 4628-4 (2016) of up to 0, and a degree of flaking according to ISO 4628-5 (2016) of up to 0.

In the magnesium alloy with a multi-level protective coating according to the disclosure, the micro-arc oxidation layer of magnesium alloy has a thickness of about 5 μm to about 20 μm, the epoxy primer layer has a thickness of about 10 μm to about 30 μm, and the polyurethane topcoat layer has a thickness of about 10 μm to about 50 μm. The selection of thicknesses of the micro-arc oxidation layer of magnesium alloy, the epoxy primer layer and the polyurethane topcoat layer is affected by the factors such as the expected service life, the surface treatment and the external corrosion, etc. In order to better play the role of corrosion resistance and enhance the adhesion of the coating, the thicknesses of the micro-arc oxidation layer of magnesium alloy, the epoxy primer layer and the polyurethane topcoat layer is preferably selected from the above ranges.

In the micro-arc oxidation process of the magnesium alloy, the microstructure of the micro-arc oxidation layer of magnesium alloy would gradually become a desertified layer with the thickness of micro-arc oxidation layer of magnesium alloy increasing, and the desertified layer on the magnesium alloy is very limited for the protective effect. Therefore, in order to make the bonding strength between the micro-arc oxidation layer of magnesium alloy and the magnesium alloy substrate so high as to adhere well to the substrate, it is preferable to use a micro-arc oxidation layer of magnesium alloy with a thickness of about 5 μm to about 20 μm.

In the magnesium alloy with a multi-level protective coating according to the disclosure, the magnesium alloy substrate used may be any series of magnesium alloys well known to those skilled in the art. For convenience and economy, for example, the magnesium alloy substrate may be selected from a group consisting of AZ21 series magnesium alloy, AZ31 series magnesium alloy, AZ91 series magnesium alloy, ZE41 series magnesium alloy, and other series magnesium alloy.

In the magnesium alloy with a multi-level protective coating according to the disclosure, the magnesium alloy with a multi-level protective coating has a period of neutral salt spray test according to ASTM B117-16 of more than about 1,000 hours, preferably more than about 1,100 hours, most preferably more than about 1,200 hours. It can be seen that the magnesium alloy with a multi-level protective coating according to the disclosure achieved the excellent corrosion resistance.

In the magnesium alloy with a multi-level protective coating according to the disclosure, the magnesium salt alloy with a multi-level protective coating after a period of neutral salt spray test according to ASTM B117-16 of more than about 1,000 hours, preferably more than about 1,100 hours, most preferably more than about 1,200 hours has a degree of blistering according to ASTM D1654-08(2016) of up to 10, a degree of rusting according to ASTM D1654-08(2016) of up to 10, a degree of cracking according to ISO 4628-4 (2016) of up to 0, and a degree of flaking according to ISO 4628-5 (2016) of up to 0. It can be seen that the magnesium alloy with a multi-level protective coating according to the disclosure achieves the excellent corrosion resistance.

In another typical embodiment of the disclosure, there is provided a process for preparing the magnesium alloy with a multi-level protective coating, comprising the following steps:
pretreatment of a magnesium alloy substrate, comprising polishing the magnesium alloy substrate, followed by acid pickling and water washing of the polished magnesium alloy substrate sequentially, to obtain a pretreated magnesium alloy substrate;
micro-arc oxidation of the pretreated magnesium alloy substrate to obtain a micro-arc oxidation layer of magnesium alloy;
formation of an epoxy primer layer on the surface of the micro-arc oxidation layer of magnesium alloy; and
formation of a polyurethane topcoat layer on the surface of the epoxy primer layer.

The magnesium alloy with a multi-level protective coating prepared by the process for preparing the magnesium alloy according to the disclosure has the excellent adhesion to the magnesium alloy substrate, while achieving a good corrosion resistance.

In order to achieve higher bonding strength of the micro-arc oxidation layer of magnesium alloy on the magnesium alloy substrate to the substrate, it is preferable to polish the surface of the magnesium alloy substrate to remove surface impurities such as the adhering impurities, and also to polish off the surface burrs, thereby lowering surface roughness. Therefore, in the process for preparing the magnesium alloy with a multi-level protective coating according to the disclosure, the pretreatment of the magnesium alloy substrate comprises:
polishing the magnesium alloy substrate with water sandpaper from coarse to fine of 200 #, 400 #, 600 #, 800 #, 1000 #, 1200 # to remove the burrs at the margins and corners to obtain a preliminary-polished magnesium alloy substrate;
polishing the preliminary-polished magnesium alloy substrate with sandpaper or abrasive wheel from coarse to fine until the surface of the preliminary-polished magnesium alloy substrate is smooth, to obtain the polished magnesium alloy substrate; and
pickling the polished magnesium alloy substrate with an acid of pH=about 0.5 to about 2 and washing with pure water to obtain the pretreated magnesium alloy substrate.

In the process for preparing the magnesium alloy with a multi-level protective coating according to the disclosure, any polyurethane and curing agent suitable for forming a polyurethane topcoat layer on the surface of the epoxy primer layer can be used, provided that they would not cause unfavorable effect on the polyurethane topcoat layer. For example, the polyurethane topcoat layer may be selected from hydroxyl-containing polyester as the resin, and the curing agent may be selected from the adduct of a polyisocyanate and a polyol.

In the process for preparing the magnesium alloy with a multi-level protective coating according to the disclosure, the process further comprises coarsen treatment of the epoxy primer layer before formation of a polyurethane topcoat layer on the surface of the epoxy primer layer, thereby making the epoxy primer layer smoother to further enhance the bonding of the epoxy primer layer to the polyurethane topcoat layer.

According to yet another aspect of the disclosure, there is provided a magnesium alloy with a multi-level protective coating produced by above-mentioned process for preparing a magnesium alloy with a multi-level protective coating. The alloy can have a period of neutral salt spray test according to ASTM B117-16 of more than about 1,000 hours, a degree of blistering according to ASTM D1654-08(2016) of up to 10, a degree of rusting according to ASTM D1654-08(2016) of up to 10, a degree of cracking according to ISO 4628-4 (2016) of up to 0, and a degree of flaking according to ISO 4628-5 (2016) of up to 0.

Compared with the existing process of the magnesium alloy surface treatment, the process according to the disclosure is simple in operation and suitable for large-scale and large-area magnesium alloy material surface treatment. The prepared magnesium alloy with a multi-layer protective coating having the micro-arc oxidation layer of magnesium alloy, the epoxy primer layer and the polyurethane topcoat has good adhesion, good appearance and morphology, and exhibits a good corrosion resistance and an exposure period of neutral salt spray resistance test (ASTM B117-16) of more than about 1,000 hours, which surpassed the corrosion resistance of most of the existing magnesium alloy surface coatings.

### EXAMPLES

### Preparation Example 1

### Pretreatment of Magnesium Alloy Substrate

First, the rectangular AZ21 series magnesium alloy substrate with a size of 150 mm×100 mm×5 mm was polished with water sandpaper from coarse to fine of 200 #, 400 #, 600 #, 800 #, 1000 #, 1200 # to remove the burrs at the margins and corners, to obtain a preliminary-polished magnesium alloy substrate, followed by polishing the preliminary-polished magnesium alloy substrate from coarse to fine with sandpaper or abrasive wheel until the surface of the preliminary-polished magnesium alloy substrate is smooth, thereby obtaining the polished magnesium alloy substrate.

Next, the polished magnesium alloy substrate was pickled, using an acid-pickling solution containing 10 mL of concentrated nitric acid+2.5 mL of concentrated sulfuric acid per liter of the solution ((10 mL of nitric acid+2.5 mL of sulfuric acid)/L solution), to remove the surface oxidation layer and to obtain a clean surface, and then rinsed with pure water for 45 seconds and dried to obtain a pre-treated magnesium alloy substrate.

### Preparation of Micro-Arc Oxidation Layer of Magnesium Alloy

To approximately 900 mL of deionized water was added 9 g of sodium silicate, 10 g of sodium hydroxide, and 10 g of sodium fluoride. The resulting mixture was stirred, until fully dissolved and dispersed, adding an appropriate amount of deionized water to obtain a 1 L micro-arc oxidation solution.

The pretreated magnesium alloy substrate as prepared above was impregnated into the micro-arc oxidation solution. A micro-arc oxidation layer of magnesium alloy is obtained by using the positive pulse current, with the current density of 0.6A/dm², the frequency of 800 Hz, the duty cycle of 30%, and the oxidation time of 15 minutes at the controlled temperature of the solution of 25 (±3) ° C. with stirring and cooling device. The micro-arc oxidation layer of magnesium alloy has a thickness of about 7-10 μm. Then, the micro-arc oxidation layer of magnesium alloy was washed with deionized water, followed by drying at about 100° C. for 15 min.

### Preparation of Epoxy Primer Layer

The epoxy primer (epoxy resin:thinner:curing agent (by weight)=1:1:0.5, mixed uniformly) was sprayed on the surface of the micro-arc oxidation layer of magnesium alloy prepared above, and dried at about 60° C. for 60 minutes, to form an epoxy primer layer on the surface of the micro-arc oxidation layer of magnesium alloy, with the thickness of the epoxy primer layer of about 17-20 μm, and followed by coarsen treatment of the epoxy primer layer.

### Preparation of Polyurethane Topcoat Layer

The polyurethane topcoat (polyurethane resin:curing agent (by weight)=3:1, mixed uniformly) was sprayed on the surface of the epoxy primer layer prepared above, and dried at a temperature of about 60° C. for 120 minutes. Polyurethane topcoat layer I was formed on the surface of the epoxy primer layer, and has a thickness of about 28-32 μm, thereby forming the magnesium alloy with a multi-level protective coating.

### Preparation Example 2

The preparation process of Preparation Example 2 was the same as Preparation Example 1, except for the polyurethane topcoat (polyurethane resin:curing agent:thinner (by weight)=7:1:3) used in the preparation of the polyurethane topcoat layer.

### Preparation of Polyurethane Topcoat Layer

The polyurethane topcoat (polyurethane resin:curing agent:thinner (by weight) =7:1:3) was sprayed on the surface of the epoxy primer layer prepared above, and dried at about 70° C. for 120 minutes, to form a polyurethane topcoat layer II on the surface of the epoxy primer layer, with the thickness of the polyurethane topcoat layer II of about 12-15 μm, thereby obtaining the magnesium alloy with a multi-level protective coating.

### Comparative Preparation Example 1

The preparation process of Comparative Preparation Example 1 was the same as Preparation Example 1, except that no polyurethane topcoat layer was prepared.

### Comparative Preparation Example 2

The preparation process of Comparative Preparation Example 2 was the same as Preparation Example 1, except that the polyurethane topcoat layer and the epoxy primer layer are both not prepared.

### Characterization of the Magnesium Alloy with a Multi-Level Protective Coating Prepared in Preparation Example 1

The magnesium alloy with a multi-level protective coating obtained in Preparation Example 1: polyurethane topcoat I/epoxy primer/micro-arc oxidation layer/AZ21 was subjected to a neutral salt spray test according to ASTM B117-16.

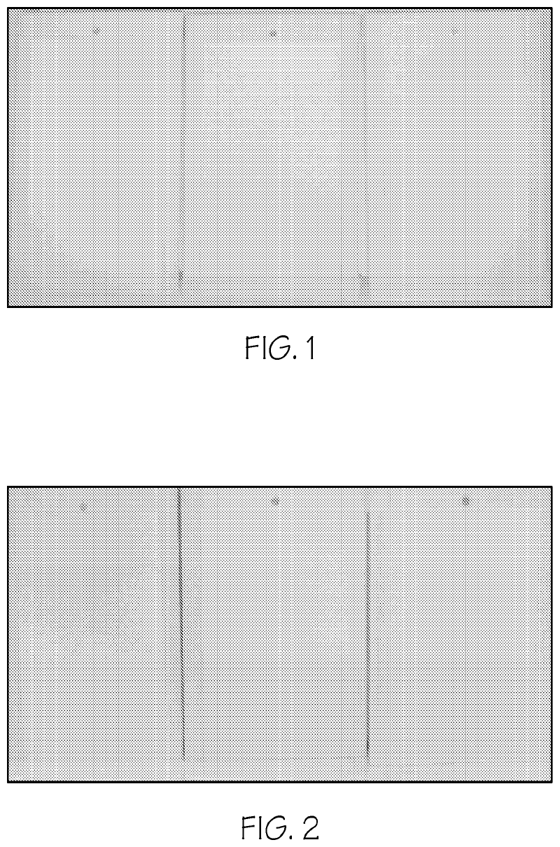

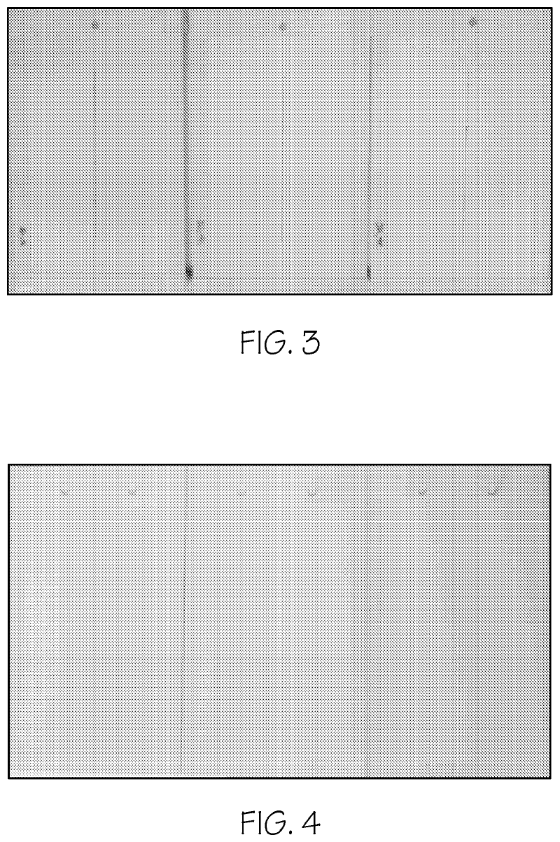

Among them, the surface morphology of the polyurethane topcoat I/epoxy primer/micro-arc oxidation layer/AZ21 according to Example 1 of the disclosure before the neutral salt spray test experiment was shown in FIG. 1; the surface morphology of the polyurethane topcoat I/epoxy primer/micro-arc oxidation layer/AZ21 according to Example 1 of the disclosure after 1,000 hours of the un-scribed neutral salt spray test was shown in FIG. 2; and the surface morphology of the polyurethane topcoat I/epoxy primer/micro-arc oxidation layer/AZ21 according to Example 1 of the disclosure after 1,000 hours of the scribed neutral salt spray test was shown in FIG. 3. It can be seen from FIGS. 1-3 that there is no corrosion on the surface morphology of the polyurethane topcoat I/epoxy primer/micro-arc oxidation layer/AZ21 according to Example 1 of the disclosure after 1,000 hours of the un-scribed neutral salt spray test (FIG. 2) an 1,000 hours of the scribed neutral salt spray test (FIG. 3), which demonstrates that the samples show better corrosion resistance: no blistering phenomena; no rust and corrosion on the sample was observed with naked eyes; and there is no cracking and flaking phenomena on the coating while no erosion phenomena or loss of coating was observed at the scribed line on scribed plaque (FIG. 3).

The above surfaces of the polyurethane topcoat I/epoxy primer/micro-arc oxidation layer/AZ21 according to Example 1 of the disclosure after 1,000 hours of the un-scribing and scribing neutral salt spray test have a degree of blistering according to ASTM D1654-08(2016) of up to 10, a degree of rusting according to ASTM D1654-08(2016) of up to 10, a degree of cracking according to ISO 4628-4 (2016) of up to 0, a degree of flaking according to ISO 4628-5 (2016) of up to 0, and a corrosion width according to ISO 4628-8(2016) of 0 mm.

### Characterization of the Magnesium Alloy with a Multi-level Protective Coating Prepared in Preparation Example 2

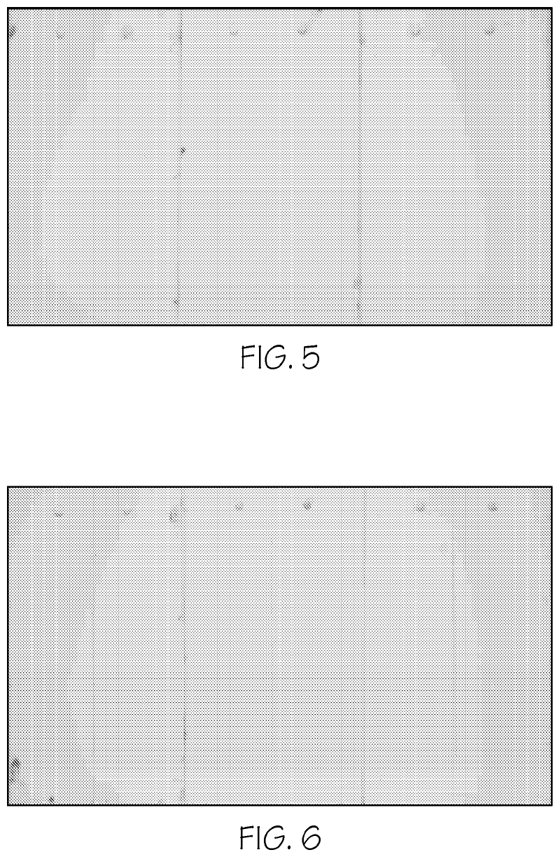

The magnesium alloy with a multi-level protective coating obtained in Preparation Example 2: polyurethane topcoat II/epoxy primer/micro-arc oxidation layer/AZ21 was subjected to a neutral salt spray test according to ASTM B117-16. The surface morphology of the polyurethane topcoat II/epoxy primer/micro-arc oxidation layer/AZ21 according to Example 2 of the disclosure before the neutral salt spray test experiment was shown in FIG. 4; the surface morphology of the polyurethane topcoat II/epoxy primer/micro-arc oxidation layer/AZ21 according to Example 2 of the disclosure after 1,200 hours of the un-scribed neutral salt spray test was shown in FIG. 5; the topography of the polyurethane II/epoxy primer/micro-arc oxidation layer/AZ21 according to Example 2 of the disclosure after 1,200 hours of the scribed neutral salt spray test was shown in FIG. 6. It can be seen from FIGS. 4-6 that there is no corrosion on the surface morphology of the polyurethane topcoat II/epoxy primer/micro-arc oxidation layer/AZ21 according to Example 2 of the disclosure after 1,200 hours of the un-scribed neutral salt spray test (FIG. 5) an 1,200 hours of the scribed neutral salt spray test (FIG. 6), which demonstrates that the samples show better corrosion resistance: no blistering phenomena; no rust and corrosion on the sample was observed with naked eyes; and there is no cracking and flaking phenomena on the coating while no erosion phenomena or loss of coating was observed at the scribed line on scribed plaque (FIG. 6).

The above surfaces of the polyurethane topcoat II/epoxy primer/micro-arc oxidation layer/AZ21 according to Example 2 of the disclosure after 1,200 hours of the un-scribed and scribed neutral salt spray test have a degree of blistering according to ASTM D1654-08(2016) of up to 10, a degree of rusting according to ASTM D1654-08(2016) of up to 10, a degree of cracking according to ISO 4628-4 (2016) of up to 0, a degree of flaking according to ISO 4628-5 (2016) of up to 0, and a corrosion width according to ISO 4628-8(2016) of 0 mm.

### Characterization of the Magnesium Alloy with a Multi-level Protective Coating Prepared in Comparative Preparation Example 1

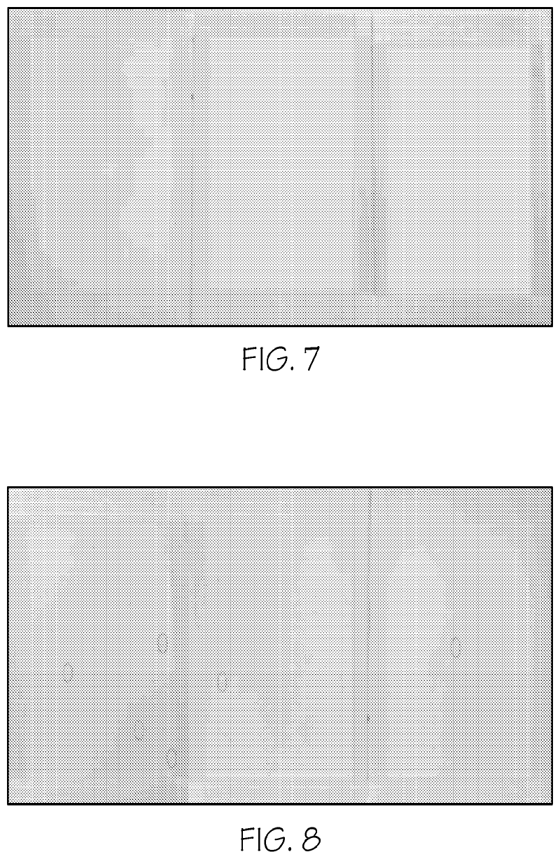

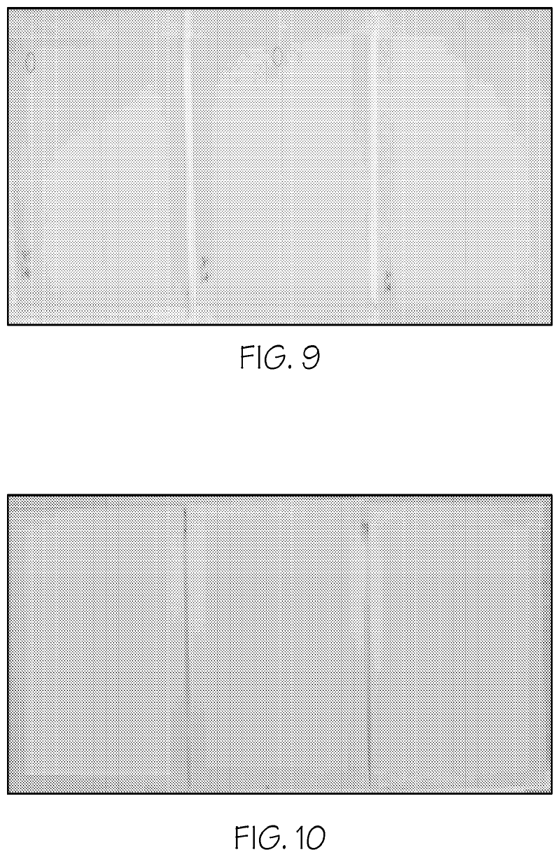

The magnesium salt alloy with a multi-level protective coating obtained in Comparative Preparation Example 1: epoxy primer/micro-arc oxidation layer/AZ21 was subjected to a neutral salt spray test according to ASTM B117-16. The surface morphology of the epoxy primer/micro-arc oxidation layer/AZ21 according to Comparative Preparation Example 1 before the neutral salt spray test and after 192 hours of the un-scribed and scribed neutral salt spray was shown in FIGS. 7, 8 and 9, respectively. It can be seen from FIGS. 7-9 that compared to the surface morphology of the epoxy primer/micro-arc oxidation layer/AZ21 according to Comparative Preparation Example 1 before the neutral salt spray test (FIG. 7), there are dark spots on the surface morphology of the epoxy primer/micro-arc oxidation layer/AZ21 according to Comparative Preparation Example 1 after 192 hours of the un-scribed neutral salt spray test (FIG. 8) and scribed neutral salt spray test (FIG. 9), and there is a certain degree of discoloration on the coating while corrosion is observed on the plaque: no blistering phenomena; the surface area of rusty white spot on the sample observed with naked eyes is greater than 0.01%-0.03% of area of the plaque and there is minor corrosion; and there is no cracking and flaking phenomena on the coating while no erosion phenomena or loss of coating was observed at the scribed line on scribed plaque (FIG. 9).

The surfaces of the epoxy primer/micro-arc oxidation layer/AZ21 according to Comparative Preparation Example 1 after 192 hours of the un-scribed and the scribed neutral salt spray test have a degree of blistering according to ASTM D1654-08(2016) of up to 10, a degree of rusting according to ASTM D1654-08(2016) of up to 9, a degree of cracking according to ISO 4628-4 (2016) of up to 0, a degree of flaking according to ISO 4628-5 (2016) of up to 0, and a corrosion width according to ISO 4628-8(2016) of 0 mm.

### Characterization of the Magnesium Alloy with a Multi-Level Protective Coating Prepared in Comparative Preparation Example 2

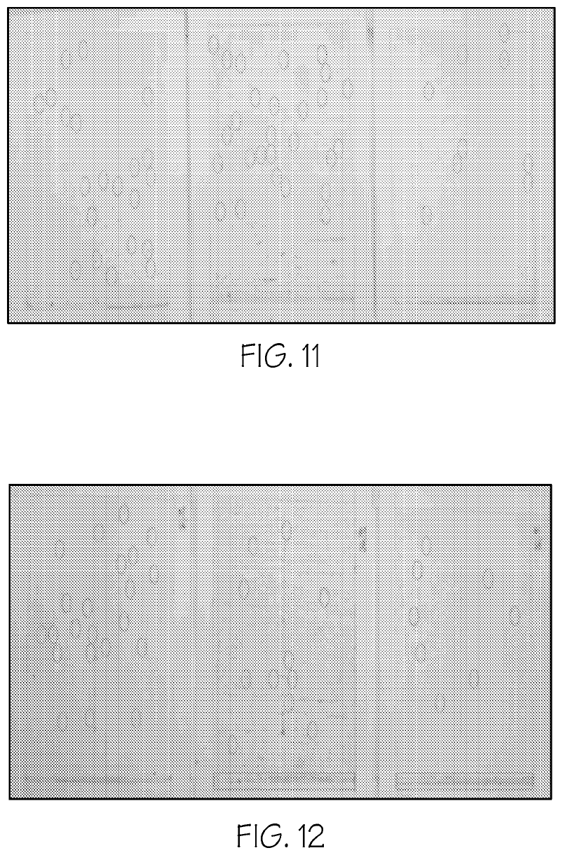

The magnesium alloy with a multi-level protective coating obtained in Comparative Preparation Example 2: Micro-arc oxidation layer/AZ21 was subjected to a neutral salt spray test according to ASTM B117-16. The surface morphology of the micro-arc oxidation layer/AZ21 according to Comparative Preparation Example 2 before the neutral salt spray test and after 96 hours of the un-scribed and scribed neutral salt spray was shown in FIGS. 10, 11 and 12, respectively. It can be seen from FIGS. 10-12 that compared to the surface morphology of the micro-arc oxidation layer/AZ21 according to Comparative Preparation Example 2 before the neutral salt spray test (FIG. 10), there are a large area of blackening on the surface morphology of the micro-arc oxidation layer/AZ21 according to Comparative Preparation Example 2 after 96 hours of the un-scribed neutral salt spray test (FIG. 11) and scribed neutral salt spray test (FIG. 12), and there is discoloration on the coating while apparent corrosion is observed on the plaque: no blistering phenomena; the surface area of rusty white spot on the sample observed with naked eyes is greater than 0.03%-0.1% of area of the plaque and there is corrosion; and there is no cracking and flaking phenomena on the coating while no erosion phenomena or loss of coating was observed at the scribed line on scribed plaque (FIG. 12).

The surfaces of the above micro-arc oxidation layer/AZ21 according to Comparative Preparation Example 2 after 96 hours of the un-scribed and the scribed neutral salt spray test have a degree of blistering according to ASTM D1654-08(2016) of up to 10, a degree of rusting according to ASTM D1654-08(2016) of up to 8, a degree of cracking according to ISO 4628-4 (2016) of up to 0, a degree of flaking according to ISO 4628-5 (2016) of up to 0, and a corrosion width according to ISO 4628-8(2016) of 0 mm.

From the above description, it can be seen that the magnesium alloy with a multi-level protective coating prepared according to the above embodiments of the disclosure achieves the following technical effects: the prepared magnesium alloy with the multi-level protective coating of magnesium oxide micro-arc oxidation layer-epoxy primer layer-polyurethane topcoat layer has a good adhesion, a good appearance and morphology, and exhibits a good corrosion resistance and a exposure period of neutral salt spray resistance test (ASTM B117-16) of more than 1000 hours, which can surpass the corrosion resistance of most of the existing magnesium alloy surface coatings.

The above are only provided the preferred embodiments of the disclosure, which is not intended to limit the disclosure. The various modification and change of the disclosure may be made for those skilled in the art. Any modification, equivalent replacement, improvement, etc. within the spirit and principle of the disclosure should be included in the protection scope of the disclosure.

Further, the disclosure comprise examples according to the following clauses:

Clause 1: A magnesium alloy comprising a magnesium alloy substrate and a multi-level protective coating on the magnesium alloy substrate, the multi-level protective coating comprising:
a micro-arc oxidation layer of magnesium alloy provided on the surface of the magnesium alloy substrate;
an epoxy primer layer provided on the surface of the micro-arc oxidation layer of magnesium alloy. And
a polyurethane topcoat layer provided on the surface of the epoxy primer layer.

Clause 2: The magnesium alloy according to Clause 1, wherein the micro-arc oxidation layer of magnesium alloy has a thickness of 5-20 μm, the epoxy primer layer has a thickness of 10-30 μm, and the polyurethane topcoat layer has a thickness of 10-50 μm.

Clause 3: The magnesium alloy according to Clause 1, wherein the magnesium alloy substrate is selected from a group consisting of AZ21 series magnesium alloy, AZ31 series magnesium alloy, AZ91 series magnesium alloy, and ZE41 series magnesium alloy.

Clause 4: The magnesium alloy according to Clause 1, wherein the magnesium alloy with a multi-level protective coating has a period of neutral salt spray test according to ASTM B117-16 of more than 1,000 hours.

Clause 5: The magnesium alloy according to Clause 1, wherein the magnesium alloy with a multi-level protective coating has a period of neutral salt spray test according to ASTM B117-16 of more than 1,100 hours.

Clause 6: The magnesium alloy according to Clause 1, wherein the magnesium alloy with a multi-level protective coating has a period of neutral salt spray test according to ASTM B117-16 of more than 1,200 hours.

Clause 7: The magnesium alloy according to any one of Clause 4-6, wherein the magnesium alloy with a multi-level protective coating has a degree of blistering according to ASTM D1654-08(2016) of up to 10, a degree of rusting according to ASTM D1654-08(2016) of up to 10, a degree of cracking according to ISO 4628-4 (2016) of up to 0, and a degree of flaking according to ISO 4628-5 (2016) of up to 0.

Clause 8: A process for preparing a magnesium alloy with a multi-level protective coating, comprising:
pretreatment of a magnesium alloy substrate, comprising polishing the magnesium alloy substrate, followed by acid pickling and water washing of the polished magnesium alloy substrate sequentially, to obtain a pretreated magnesium alloy substrate;
micro-arc oxidation of the pretreated magnesium alloy substrate to obtain a micro-arc oxidation layer of magnesium alloy;
formation of an epoxy primer layer on the surface of the micro-arc oxidation layer of magnesium alloy; and
formation of a polyurethane topcoat layer on the surface of the epoxy primer layer.

Clause 9: The process for preparing a magnesium alloy with a multi-level protective coating according to Clause 8, wherein the pretreatment of the magnesium alloy substrate comprises:
polishing the magnesium alloy substrate with water sandpaper from coarse to fine of 200 #, 400 #, 600 #, 800 #, 1000 #, 1200 # to remove the burrs at the margins and corners to obtain a preliminary-polished magnesium alloy substrate;
polishing the preliminary-polished magnesium alloy substrate with sandpaper or abrasive wheel from coarse to fine until the surface of the preliminary-polished magnesium alloy substrate is smooth to obtain the polished magnesium alloy substrate; and
pickling the polished magnesium alloy substrate with an acid of pH=0.5 to 2 and washing with pure water to obtain the pretreated magnesium alloy substrate.

Clause 10: The process for preparing a magnesium alloy with a multi-level protective coating according to Clause 9, wherein further comprising coarsen treatment of the epoxy primer layer before formation of the polyurethane topcoat layer on the surface of the epoxy primer layer.

Clause 11: A magnesium alloy with a multi-level protective coating produced by the process for preparing a magnesium alloy with a multi-level protective coating according to any one of Clause 8-10.

What is claimed is:

1. A magnesium alloy comprising a magnesium alloy substrate and a multi-level protective coating on the magnesium alloy substrate, the multi-level protective coating comprising:
a micro-arc oxidation layer of magnesium alloy provided on a surface of the magnesium alloy substrate;
an epoxy primer layer provided on a surface of the micro-arc oxidation layer of magnesium alloy; and
a polyurethane topcoat layer provided on a surface of the epoxy primer layer.

2. The magnesium alloy according to claim 1, wherein the micro-arc oxidation layer of magnesium alloy has a thickness of 5-20 μm.

3. The magnesium alloy according to claim 1, wherein the epoxy primer layer has a thickness of 10-30 μm.

4. The magnesium alloy according to claim 1, wherein the polyurethane topcoat layer has a thickness of 10-50 μm.

5. The magnesium alloy according to claim 1, wherein the micro-arc oxidation layer of magnesium alloy has a thickness of 5-20 μm, the epoxy primer layer has a thickness of 10-30 μm, and the polyurethane topcoat layer has a thickness of 10-50 μm.

6. The magnesium alloy according to claim 1, wherein the magnesium alloy substrate is selected from a group consisting of AZ21 series magnesium alloy, AZ31 series magnesium alloy, AZ91 series magnesium alloy, and ZE41 series magnesium alloy.

7. The magnesium alloy according to claim 1 having a period of neutral salt spray test according to ASTM B117-16 of more than 1,000 hours.

8. The magnesium alloy according to claim 7 having a degree of blistering according to ASTM D1654-08(2016) of up to 10, a degree of rusting according to ASTM D1654-08(2016) of up to 10, a degree of cracking according to ISO 4628-4 (2016) of up to 0, and a degree of flaking according to ISO 4628-5 (2016) of up to 0.

9. The magnesium alloy according to claim 1 having a period of neutral salt spray test according to ASTM B117-16 of more than 1,100 hours.

10. The magnesium alloy according to claim 9 having a degree of blistering according to ASTM D1654-08(2016) of up to 10, a degree of rusting according to ASTM D1654-08(2016) of up to 10, a degree of cracking according to ISO 4628-4 (2016) of up to 0, and a degree of flaking according to ISO 4628-5 (2016) of up to 0.

11. The magnesium alloy according to claim 1 having a period of neutral salt spray test according to ASTM B117-16 of more than 1,200 hours.

12. The magnesium alloy according to claim 11 having a degree of blistering according to ASTM D1654-08(2016) of up to 10, a degree of rusting according to ASTM D1654-08(2016) of up to 10, a degree of cracking according to ISO 4628-4 (2016) of up to 0, and a degree of flaking according to ISO 4628-5 (2016) of up to 0.

13. A process for preparing a magnesium alloy with a multi-level protective coating, comprising:
pretreatment of a magnesium alloy substrate;
micro-arc oxidation of the pretreated magnesium alloy substrate to obtain a micro-arc oxidation layer of magnesium alloy;
formation of an epoxy primer layer on the surface of the micro-arc oxidation layer of magnesium alloy; and
formation of a polyurethane topcoat layer on the surface of the epoxy primer layer.

14. The process according to claim 13 wherein the pretreatment of the magnesium alloy substrate comprises polishing the magnesium alloy substrate to yield a polished magnesium alloy substrate.

15. The process according to claim 14 wherein the pretreatment of the magnesium alloy substrate further comprises acid pickling and water washing of the polished magnesium alloy substrate sequentially.

16. The process according to claim 15, wherein the pretreatment of the magnesium alloy substrate comprises:
polishing the magnesium alloy substrate with water sandpaper from coarse to fine of 200 #, 400 #, 600 #, 800 #, 1000 #, 1200 # to remove burrs at margins and corners to obtain a preliminary-polished magnesium alloy substrate;
polishing the preliminary-polished magnesium alloy substrate with sandpaper or abrasive wheel from coarse to fine until a surface of the preliminary-polished magnesium alloy substrate is smooth to obtain the polished magnesium alloy substrate; and
pickling the polished magnesium alloy substrate with an acid of pH=0.5 to 2 and washing with pure water to obtain the pretreated magnesium alloy substrate.

17. The process according to claim 13 further comprising coarsen treatment of the epoxy primer layer before formation of the polyurethane topcoat layer on the surface of the epoxy primer layer.

18. The process according to claim 13, wherein the magnesium alloy substrate is selected from a group consisting of AZ21 series magnesium alloy, AZ31 series magnesium alloy, AZ91 series magnesium alloy, and ZE41 series magnesium alloy.

19. A magnesium alloy with a multi-level protective coating produced by the process for preparing a magnesium alloy with a multi-level protective coating according to claim 13.

20. The magnesium alloy of claim 19 having:
a period of neutral salt spray test according to ASTM B117-16 of more than 1,000 hours,
a degree of blistering according to ASTM D1654-08(2016) of up to 10,
a degree of rusting according to ASTM D1654-08(2016) of up to 10,
a degree of cracking according to ISO 4628-4 (2016) of up to 0, and
a degree of flaking according to ISO 4628-5 (2016) of up to 0.
